(19) United States
(12) Patent Application Publication
(10) Pub. No.: US 2024/0382037 A1
(43) Pub. Date: Nov. 21, 2024

(54) ASSEMBLY TYPE COOKING DEVICE FOR OUTDOOR ACTIVITIES

(71) Applicant: IKAMPER CO., LTD, Paju-si, Gyeonggi-do (KR)

(72) Inventor: Soon Gyu PARK, Paju-si, Gyeonggi-do (KR)

(73) Assignee: IKAMPER CO., LTD, Paju-si, Gyeonggi-do (KR)

(21) Appl. No.: 17/917,897

(22) PCT Filed: Sep. 15, 2022
(86) PCT No.: PCT/KR2022/013759

§ 371 Date: Oct. 7, 2022

(30) Foreign Application Priority Data
Sep. 25, 2021 (KR) 10-2021-0126781
Oct. 8, 2021 (KR) 10-2021-0134199

(51) Int. Cl. A47J 36/26

(52) U.S. Cl. CPC A47J 36/26

(57) ABSTRACT

An assembly type cooking device for outdoor activities. The assembly type cooking device for outdoor activities includes a coupling part and a plurality of lower support parts rotatably connected to the lower side of the coupling part, provided to be adjustable in length, and radially disposed from the center of the coupling part.

### TECHNICAL FIELD

The present invention relates to an assembly type cooking device for outdoor activities.

### BACKGROUND

Due to an increased income and improved life conditions, there is an increasing number of people seeking to enjoy leisure activities such as travel, fishing, camping, etc. At this time, leisure activities such as travel, fishing, camping, etc. are mainly outdoor activities that occur outdoors, and therefore outdoor equipment capable of cooking food outdoors is required for people who enjoy the outdoor activities to solve their meals during outdoor activities.

On the other hand, as an example of such an outdoor article, there has been proposed a camping tripod with easy height adjustment of the Dutch oven of South Korea Utility Model Publication No. 20-0425597. A camping tripod with easy adjustment of the height of the oven in South Korea Utility Model Publication No. 20-0425597, wherein the front ends of the three support rods are coupled to the connecting ring, and the lower ends thereof are selectively installed on the ground. At this time, a separate connector is connected between the front end and the lower end of the support rod, and a chain is connected to this connector. Here, one end of the chain is provided with a hook for hooking a Dutch oven, and the other end of a chain is equipped with an end fixture that can be secured to the support rod. Accordingly, when the end fixture is lifted up and down relative to the support rod in a state in which the hook is hung with the Dutch oven, the distance between the ground and the Dutch oven is adjusted.

However, in the conventional camping tripod, the connecting ring and the supporting rods are simply coupled in such a manner that the circular connecting ring penetrates through the three supporting rods, and when the supporting bars are gathered inside the connecting rings, there is no member for fixing the support rods gathered inside of the connecting rods, which is troublesome to carry.

In addition, in the conventional camping tripod, the distance between the ground and the Dutch oven is adjusted according to the connection position of the end fixture connected to the support bar, but the length of the support rod itself is not adjusted, so there is a limit to adjust the distance between the ground and the Dutch oven, and thus the usability is reduced.

In addition, since the conventional camping tripod has a circular connecting ring simply connected through the three supporting rods, there is a limit to the supporting force of the connecting ring supporting the supporting rods when they are extended outside the connecting rings, and thus there is the problem that the structural stability is deteriorated.

In addition, in the conventional camping tripod, since the user has to directly move the end fixture fitted to the support rod in the up-down direction in order to adjust the distance between the ground and the Dutch oven, there is a problem that adjustment of the distance from the ground to the Dutch oven is cumbersome, and the position of the end fixture fitted to a support rod is changed depending on the user's feeling, so that the distance of the ground from the Dutch oven cannot be finely adjusted.

Therefore, there is a need for an assembly type cooking device for outdoor activities, which is provided in an assembly manner and convenient to carry, is provided height-adjustable to improve usability, can be used without shaking even in a height-adjusted state by ensuring excellent structural stability, and can finely adjust a distance between a ground and a cooking tool.

### SUMMARY

The present invention relates to an assembly type cooking device for outdoor activities. The assembly type cooking device for outdoor activities according to the embodiment of the present invention comprises a coupling part; and a plurality of lower support parts rotatably connected to the lower side of the coupling part, provided to be adjustable in length, and radially disposed from the center of the coupling part.

Embodiments of the present invention have been made to solve the above-mentioned conventional problems, and provide an assembly type cooking device for outdoor activities, which is provided in an assembly manner and convenient to carry, is provided to be adjustable in height so as to improve ease of use, can be used without shaking even when the height is adjusted, and is provided to finely adjust the distance between the ground and the cooking tool.

According to an aspect of the present invention, an assembly type cooking device for outdoor activities comprising: a coupling part; and a plurality of lower support parts rotatably connected to the lower side of the coupling part, provided to be adjustable in length, and radially disposed from the center of the coupling part may be provided.

Further, the lower support part may comprise a first support member rotatably coupled to the coupling part; a second support member movably coupled to the first support member; and a first length adjustment part provided on the first and second support members, the first length adjustment part fixing the second support member moved relative to the first support member to the first support member.

In addition, the lower support part may further comprise a third support member movably coupled to the second support member; and a second length adjustment part provided on the second and third support members, and the second length adjustment part fixing the third support member moved relative to the second support member to the second support member.

In addition, a plurality of contact members may be provided inside the coupling part, the contact member is disposed outside the first support member and is provided to surround at least a portion of a circumferential surface of the first support member.

In addition, the contact member may include a protrusion formed to protrude from one surface of an outer peripheral surface, and the protrusion is provided so that an end portion is in contact with the inner peripheral surface of the coupling part.

Further, a support jaw for selectively supporting the first support member may be provided on the inner surface of the contact member.

Further, the coupling part may comprise a first coupling frame to which the plurality of the lower support parts is rotatably coupled; and a second coupling frame provided on the first coupling frame.

Further, the first coupling frame may comprise a first connecting part; a plurality of second connecting parts radially connected from the center of the first connecting part and rotatably connected to the lower support part; and a protrusion provided on at least a portion of the inner surface of the second connecting part.

Further, the contact member may be provided between the first connecting part and the second connecting part, and the first support member rotating between the first connecting part and the second connecting part is supported by the support jaw.

Further, the present invention may further comprise a plurality of upper support parts selectively coupled to the upper side of the coupling part, disposed radially from the center of the coupling part and having a seating groove, wherein the seating groove provided in the plurality of the upper support parts are radially disposed from the center of the coupling part to form a support structure.

Further, the coupling part may comprise a first coupling frame to which the plurality of the lower support parts is rotatably coupled; and a second coupling frame provided on the first coupling frame, and to which the plurality of the upper support parts is selectively coupled.

Further, the second coupling frame may comprise a third coupling part; and a plurality of fourth coupling parts radially connected from the center of the third coupling part and to which the upper support part is selectively coupled, and wherein the fourth coupling part is provided with an insertion slit into which the upper support part can be inserted.

Further, the upper support part may comprise an insertion portion provided to be insertable into the insertion slit; a latching portion connected to the insertion portion, the latching portion selectively interfering with the inner surface of the insertion slit to prevent the insertion portion inserted into the insertion slit from being detached from the insertion slit; and an extension support part extending from the insertion portion and provided with the seating groove.

Further, the upper supporter may comprise a rotation support bar rotatably coupled to the upper side of the coupling part; and at least one movable support bar movably coupled with the rotation support bar, wherein the seating groove is provided in at least one of the rotation support bar and the movable support bar.

Further, the present invention may further comprise a cooking heat source generating unit selectively seated in the seating groove disposed radially from the center of the coupling part and supported by the upper support part.

Further, the cooking heat source generating unit may comprise a seating frame capable of being seated on and supported by the seating groove; and a heat source generating device coupled to the seating frame.

Further, the present invention may further comprise a cooking device fixing part provided on the lower side of the coupling part inside a plurality of the lower support parts radially disposed from the center of the coupling part.

Further, the cooking device fixing part may further comprise a fixed frame selectively fixed to the lower side of the coupling portion, and wherein the fixed frame comprises: a fastening part selectively fastened to the lower side of the coupling part; a first extension part extending from both ends of the fastening part; and a second extension part extending from both ends of the first extension part.

Further, the cooking device fixing part may comprise a wheel member rotatably provided to the second extension part and provided so that a cooking device connecting means is selectively wound around the circumferential surface; and an adjustment bar rotatably provided in the first extension part.

Further, the adjustment bar may comprise a rotation connecting part rotatably connected to the first extension part; a contact part extending from the end of the rotation connecting part and provided to be in contact with the cooking device connecting means wound around the circumferential surface of the wheel member; and an external force applying part connected to the contact part, and wherein the contact part comprises an inclined part that the cooking device connecting means wound on the circumferential surface of the wheel member can ride over.

Further, the contact part may further comprise a fixing piece for improving a contact area with the cooking device connecting means wound on the circumferential surface of the wheel member.

Further, the cooking device fixing part may further comprise a rotation limiting member coupled to the first extension and provided to interfere with the adjustment bar to limit rotation of the adjustment bar.

Further, the present invention may further comprise a table member selectively mounted to the lower support part.

Further, the table member may comprise a table body; a mounting part provided on at least a portion of the peripheral surface of the table body and provided in close contact with at least a portion of the peripheral surface of the lower support part to mount the table body to the lower support part; and a seating support part provided on the table body.

The assembly type cooking device for outdoor activities according to the embodiments of the present invention is provided as an assembly type and convenient to carry, is provided height-adjustable to improve usability, can be used without shaking even in a height-adjusted state by ensuring excellent structural stability, and has an effect that the distance between the ground and the cooking tool can be finely adjusted.

### BRIEF DESCRIPTION OF THE DRAWINGS

FIG. 1 is a plan perspective view showing an assembly type cooking device for outdoor activities according to an embodiment of the invention.

FIG. 2 is a bottom perspective view showing the assembly type cooking device for outdoor activities of FIG. 1.

FIG. 3 is an enlarged view of part A of FIG. 2.

FIG. 4 is an exploded perspective view of the assembly type cooking device for the outdoor activities of FIG. 1.

FIG. 5 is a plan perspective view showing a plurality of lower support parts of the assembly type cooking device for outdoor activities of FIG. 1.

FIG. 6 is a cross-sectional view taken along the line B-B of FIG. 2.

FIG. 7 is a cross-sectional view taken along the line C-C of FIG. 2.

FIG. 8 is a side view showing the cooking device fixing part of the assembly type cooking device for outdoor activities shown in FIG. 1.

FIG. 9 is a first use state diagram of the assembly type cooking device for outdoor activities of FIG. 1.

FIG. 10 is a second use state diagram of the assembly type cooking device for outdoor activities of FIG. 1.

FIG. 11 is a view showing a third use state of the assembly type cooking device for outdoor activities of FIG. 1.

FIG. 12 is a plan perspective view showing an assembled cooking device for outdoor according to another embodiment of the present invention.

FIG. 13 is a plan view showing a table member of the assembly type cooking device for outdoor activities of FIG. 12.

FIG. 14 is a perspective view showing a modification of the table member of the assembly type cooking device for outdoor activities of FIG. 12.

FIG. 15 is a perspective view of a prefabricated cooking device for outdoor use according to another embodiment of the present invention.

FIG. 16 is a plan view showing an upper support part of the assembly type cooking device for outdoor activities of FIG. 15.

FIG. 17 is a perspective view showing an assembly type cooking device for outdoor activities according to another embodiment of the present invention.

### DETAILED DESCRIPTION

Hereinafter, specific embodiments for implementing the concept of the present invention will be described in detail with reference to the drawings.

Further, in the description of the present invention, when it is determined that a detailed description of a related known configuration or function may obscure the gist of the invention, the detailed description thereof is omitted.

In addition, it will also be understood that when an element is referred to as being “coupled,” “connected,” to another element, it can be directly coupled or connected to the other element or intervening elements may be present.

The terminology used herein is only for the purpose of describing particular embodiments and is not intended to be limiting of the invention. The indefinite articles “a” and “an” include plural referents unless the context clearly dictates otherwise.

Further, it should be noted that, in this specification, expressions such as one side, another side, upper side, lower side and the like are described with reference to the drawings and may be expressed differently when the orientation of the object is changed. For the same reason, some components are exaggerated, omitted, or schematically illustrated in the accompanying drawings, and the size of each component does not entirely reflect the actual size.

Furthermore, although terms including ordinal numbers such as first, second, etc. may be used to describe various elements, the elements are not limited by such terms. These terms are only used to distinguish one element from another.

As used in the specification, the meaning of ‘comprising’ specifies particular feature, regions, constants, steps, acts, elements and/or components, and does not exclude the presence or addition of other particular features or regions, constants, steps or acts, components or groups.

Hereinafter, an assembly type cooking device for outdoor activities according to an embodiment of the present invention will be described with reference to the drawings.

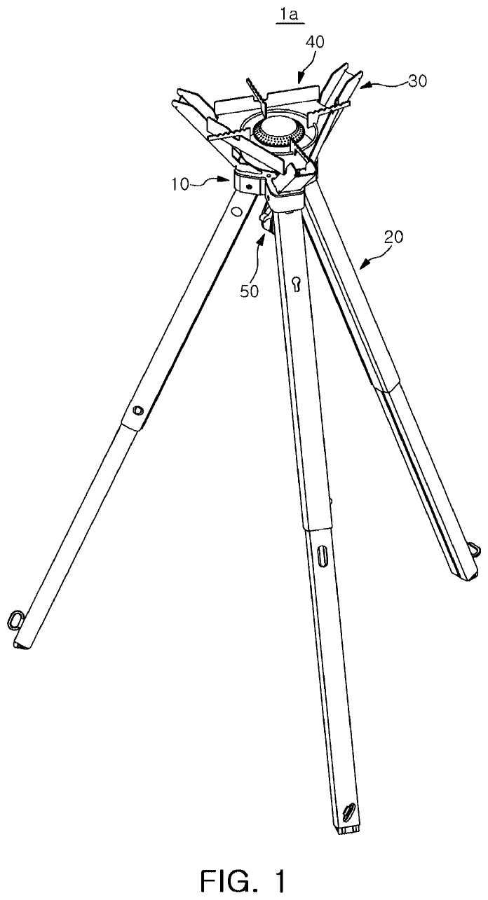

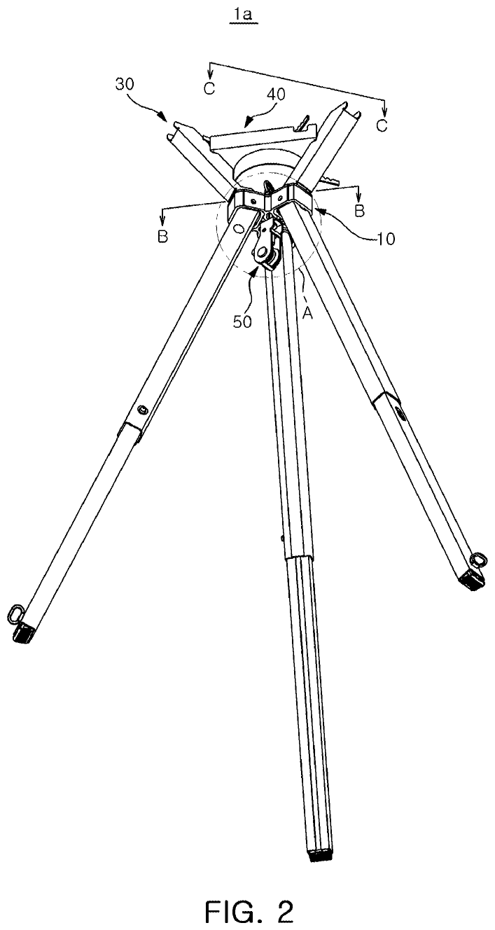

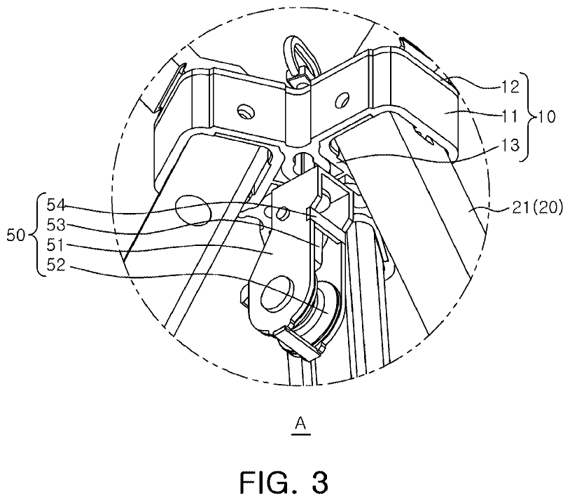

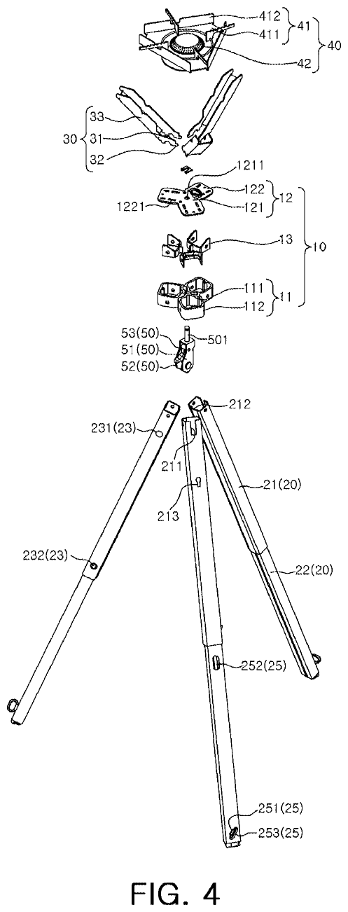

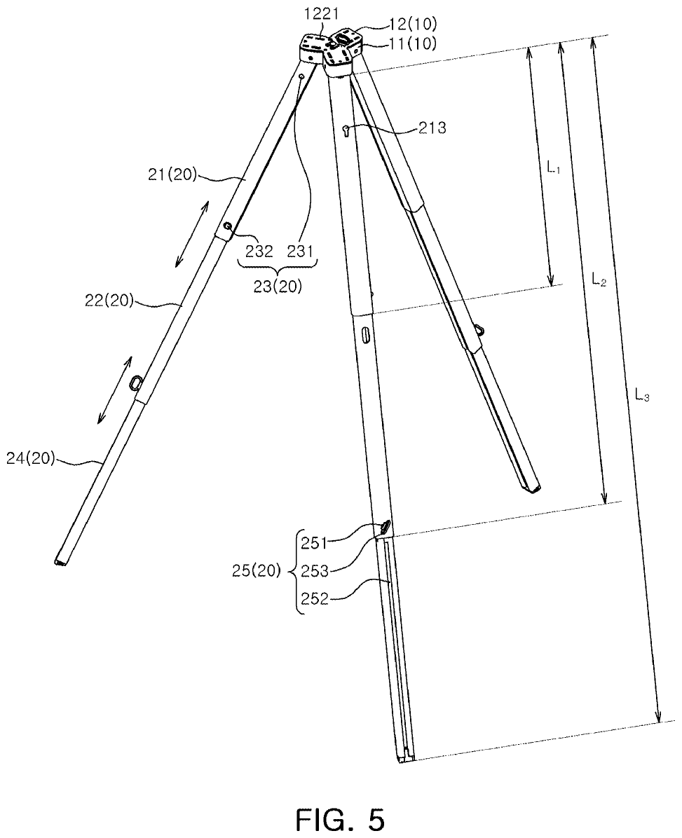

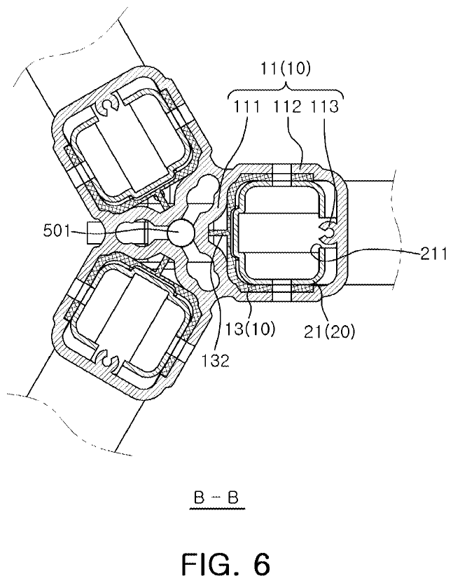

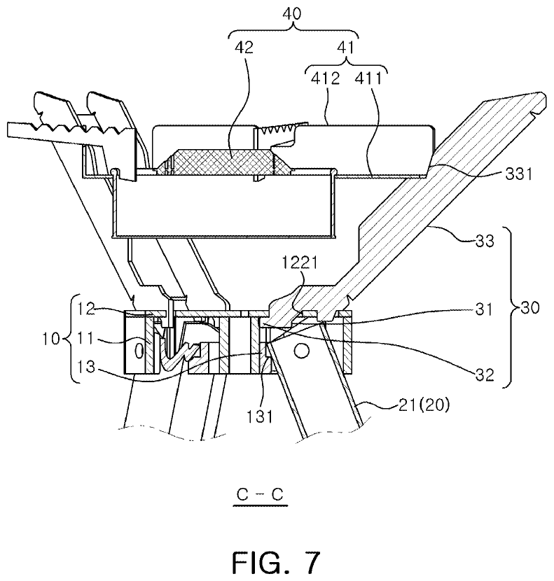

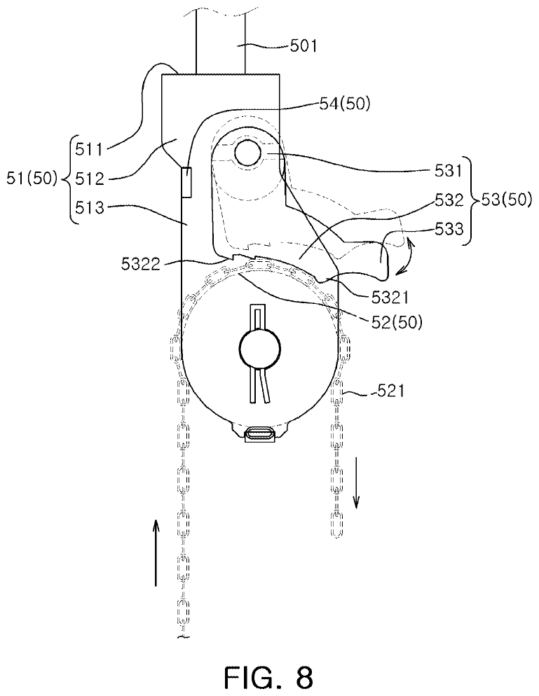

Referring to FIGS. 1 to 8, an assembly type cooking device for outdoor activities 1a according to an embodiment of the present invention may include a coupling part 10, a plurality of lower support parts 20, a plurality of upper support parts 30, an cooking heat source generating unit 40, and a cooking device fixing part 50. The coupling part 10 is a portion to which at least one of the plurality of lower support parts 20 and the plurality of upper support parts 30 is coupled, and at least either one of the plurality of the lower support parts 20 and the plurality of the upper support parts 30 coupled to the coupling part may be disposed radially with respect to the center of the coupling part 10. This coupling part 10 may comprise a first coupling frame 11, a second coupling frames 12 and a contact member 13. The first coupling frame 11 is a portion to which the plurality of lower support parts 20 is rotatably coupled, so that the plurality of lower support parts 20 coupled to the first coupling frames 11 can be relatively rotated with respect to the first coupling frame 11, without being blocked by and detached from the first coupling frame 11. To this end, the first coupling frame 11 may comprise a first connecting part 111 to which the cooking device fixing part 50 is selectively connected, a plurality of second connecting parts 112 radially connected from the center of the first connecting part 111 and to which the lower support part 20 is rotatably connected, and a protrusion 113 provided on at least a portion of the inner surface of the second connecting part 112.

The first connecting part 111 may form a space in which a coupling member 501 connected to the fixing frame 51 of the cooking device fixing part 50, which will be described later, can be coupled, and may form, a space in which the first support member 21 of the lower support part 20, which will be described later together with the second connecting part 112, can be rotatably engaged. The second connecting part 112 may form a space in which the first support member 21 of the lower support part 20 described later together with the first connecting part 111, can be rotatably coupled. In this case, the second connecting part 112 may be formed integrally with the first connecting part 111. The protrusion 113 can prevent the flow of the first support member 21 rotated in the space formed by the first connecting part 111 and the second connecting part 112. For this purpose, the protrusion 113 may be provided so as to be at least partially insertable into a cut-out portion 211 provided in the first support member 21 of the lower support part 20, described later. To this end, the protrusion 113 may be formed to protrude from at least a portion of the inner surface of the second connecting part 112. For example, when the first support member 21 is rotated in the space formed by the first connecting part 111 and the second connecting part 112, the protrusion 103 may protrude from at least a part of the inner surface of the second connecting part 112 to such an extent that at least a portion of the protrusions 123 may pass through the cut-out portion 211 provided in the first support member 21 and enter the inside of the first support member 21.

The second coupling frame 12 is a portion to which the plurality of upper support parts 30 are selectively coupled, and may be provided on the first coupling frame 11. This second coupling frame 12 may comprise a third coupling part 121 arranged on the first coupling part 111 and the second connecting part 112, and radially connect from the center of the third connecting part 121, and comprise a plurality of fourth coupling parts 122 to which the upper support part 30 is selectively connected. The third connecting part 121 may cover the top of the first connecting part 111. The third connecting part 121 may be provided with a fastening hole 1211 for a fastening member 501 connected to a fixing frame 51 of a cooking device fixing part 50 to be described later. The fourth connecting part 122 may cover the top of the second connecting part 112. This fourth connecting part 122 may be provided with an insertion slit 1221 into which the upper support part 30 may be inserted. For example, the insertion slit 1221 may be provided in a number corresponding to the number of insertion portions 31 of the upper support part 30 to be described later.

The contact member 13 can support the rotated first support member 21 when the first support members 21 of the lower support part 20, which will be described later, are rotated in a space surrounded by the first connecting part 111 and the second connecting part 112. To this end, the contacting member 13 may be disposed outside the first support member 21 of the lower support part 20 to be described later. For example, the contact member 13 may be provided in a shape capable of surrounding at least one portion of the peripheral surface of the first support member 21 of the lower support part 20 described later.

On the other hand, a support jaw 131 on which the first support member 21 can be selectively supported may be provided on the inner surface of the contact member 13. The contact area between the contact member 13 and the first support member 21, which is rotated in the space surrounded by the first connecting part 111 and the second connecting part, can be improved by this support jaw 131. Further, a protrusion 132 formed to protrude from one surface of the outer peripheral surface of the contact member 13 may be provided. Such a protrusion 132 may be provided such that an end of the protrusion is in contact with the inner peripheral surface of the first coupling frame 11 and may be formed to protrude in a direction toward the center of the lower support part 20, as an example. However, this is merely an example, and it is also possible to protrude in a direction away from the center of the lower support part 20, or in other directions. Such a contact member 13 may be made of, for example, a flexible synthetic resin material, and when the position of the lower support part 20 including the first support member 21 is adjusted by the user, the position thereof can be easily adjusted by giving a tough feeling to the user as the upper end of the first support member 21 is elastically fixed by the contact member 13. The plurality of lower support parts 20 allow the cooking device seated on the plurality of upper support parts 30 or the cooking device connected to the cooking device fixing part 50 to be used without shaking. For this purpose, a plurality of lower support parts 20 may be provided on the lower side of the coupling part 10 so as to be stably fixed to the ground of the place where the outdoor activity takes place, and may be rotatably connected to the coupling part 10. The plurality of lower support parts 20 rotatably connected to the coupling part 10 in this manner may, for example, be extended in a direction away from the center of the coupling part 10, or may be gathered in the direction closer to the center of the coupling part 10. At this time, the plurality of lower support parts 20 coupled to the lower side of the coupling part 10 may be disposed radially from the center of the coupled part 10. Hereinafter, for convenience of description, a case in which one end of the lower support part 20 is coupled to the coupling part 10 and the other end thereof is fixed to the ground will be described as an example.

On the other hand, when it is necessary to use the prefabricated cooking apparatus 1a for outdoor use, one end of each of the plurality of lower support portions 20 can be rotated in one direction. Here, one direction means a clockwise direction with reference to FIG. 1. When one end portion of each of the plurality of lower support portions 20 is rotated in one direction in this way, the other end portion thereof can be moved in a direction away from the center of the engagement portion 10. Accordingly, since the size of the virtual triangle formed by the other ends of the plurality of lower support portions 20 is larger than the size thereof formed by one end of the plural lower support portion 22, structural stability can be secured.

Next, when the use of the assembly type cooking device for outdoor activities 1a is completed, one end of each of the plurality of lower support parts 20 can be rotated in the other direction. Here, the other direction means a counterclockwise direction with reference to FIG. 1. At this time, as both ends of the plurality of lower support parts 20 are moved toward the center of the coupling portion 10 in the approaching direction, the size of the virtual triangle formed by one end portion of the plural lower support part 20 is substantially the same as that formed by the other end portion thereof, so that the ease of maintenance can be improved.

On the other hand, the plurality of lower support parts 20 can adjust the distance between the cooking device resting on the plurality of the upper support part 30 and the ground or the distance between the cooking device connected to the cooking device fixing part 50 and the ground via the cooking device connecting means 521. In this case, the lower support part 20 may be provided to be adjustable in height to form various lengths (the first length L1, the second length L2, and the third length L3). Accordingly, after setting the length of the lower support part 20 to a length that meets the user's physical condition or the purpose of use of the user, the user's convenience can be improved by adjusting the height of the lower support part 20 and using it.

To this end, the lower support part 20 includes the first support member 21, the second support member 22, the first length adjustment part 23, the third support member 24, and the second length adjustment part 25.

The first support member 21 may be rotatably coupled to the first coupling frame 11 through a separate hinge member (not shown). In this case, a cut-out portion 211 through which at least a portion of the protrusion 113 may pass may be provided at one end of the first support member 21. The first support member 21 may include a matching portion 212 formed at a position opposite to the cut-out portion 211. The matching portion 212 may be provided in a shape corresponding to the shape of the inner surface of the contact member 13 to match the inner surface of the contact member 13. At this time, the first support member 21 may be provided with a mounting hole 213 to which a separate bracket 214 can be coupled. A gas container 2 in which a gas for supplying a heat source generating device 42 of a heat source generating unit 40 for cooking to be described later is stored may be mounted on the bracket 214.

The second support member 22 may be movably coupled to the first support member 21. A third support member 24 may be movably coupled to the second support member 22. At this time, the second support member 22 moved with respect to the first support member 21 may be fixed by the first length adjustment part 23, and the third support member 24 moved with respect to the second support member 22 may be fixed by the second length adjustment part 25. At this time, the first length adjustment part 23 includes at least two insertion hole parts 231 provided in any one of the first support member 21 and the second support member 22, and an elastic insertion protrusion provided in the other of the first support member 21 and the second support member 21 and selectively inserted to the insertion hole parts 231. Lengths formed by the first support member 21 and the second support member 22 may be determined according to the position of the insertion hole 231 into which the elastic insertion protrusion 232 is inserted. Briefly describing a method in which the elastic insertion protrusion 232 is inserted into the insertion hole 231, when the second support member 22 or the first support member 21 moved with respect to the first support member 21 or the second support member 22 meet the elastic insertion protrusion 232, the elastic insertion protrusion 232 exposed to the outside through the insertion hole part 231 is compressed to generate a restoring force, and when the second support member 22 or the first support member 21 passes through the elastic insertion protrusion 232, the elastic insertion protrusion 232 can be exposed to the outside again through the insertion hole part 231 of the first support member 21 or the second support member 22 due to the generated restoring force. The second length adjustment part 25 includes a length adjustment hole part 251 provided in any one of the second support member 22 and the third support member 24, a length adjustment slit 252 provided in the other of the second support member 22 and the third support member and a length adjustment fastening member 253 passing through the length adjustment slit 252 and the length adjustment hole part 251 and configured to be fastened. Depending on the point where the length adjustment hole 251 and the length adjustment slit 252 meet, the lengths formed by the second support member 22 and the third support member 24 may vary.

The plurality of upper support parts 30 may selectively support the cooking heat source generating unit 40. To this end, the plurality of upper support parts 30 may be selectively coupled to the upper side of the coupling part 10 and may be radially disposed from the center of the coupling part 10. For example, the plurality of upper support parts 30 are coupled to the upper side of the coupling part 10 only when the use of the assembly type cooking device for outdoor activities 1a is required, and it may be separated from the coupling part 10 and stored separately when the use of the assembly type cooking device for outdoor activities 1a is completed. The upper support part 30 is connected to the insertion portion 31 provided to be inserted into the insertion slit 1221, and the latching portion 32 connected to the insertion portion 31 and selectively interfered with the inner surface of the insertion slit 1221 to prevent the insertion portion 31 inserted into the insertion slit 1221 from being separated from the insertion slit 1221 and the extension support part 33 extending from the insertion portion 31.

Briefly describing the method of fastening the upper support part 30 to the upper side of the coupling part 10, when the latching part 32 and the insertion portion 31 are inserted into the insertion slit 1221, the latching part 32 is blocked on the inner surface of the insertion slit 1221 and cannot be separated from the insertion slit 1221, and the upper support part 30 can be intuitively fastened to the upper side of the coupling part 10 by simply entering the latching part 32 and the inserting part 31 into the insertion slit 1221.

On the other hand, the extension support part 33 may be provided with a seating groove 331 in which the seating frame 41 of the cooking heat source generating unit 40 to be described later can be supported. At this time, the seating grooves 331 may be provided in each of the plurality of extension support part 33, and the plurality of seating grooves 331 are radially disposed from the center of the coupling part 10 to form a support structure which can support the seating frame 41. At least one of these seating grooves 331 may be provided along the extending direction of the extension support part 33. The position at which the seating groove 331 is provided may be determined to correspond to the size of the seating frame 41 of the cooking heat source generating unit 40 to be described later. In other words, depending on the position at which the seating groove 331 is provided, prefabricated seating frames 41 of various sizes may be seated and supported on the extension support part.

A heat source generating device 42 of a cooking heat source generating unit 40 to be described later is coupled to the seating frame 41 supported by the seating groove 331, and a separate cooking device (not shown) can be raised and used in the heat source generating device 42. In this case, the end of the extension support part 33 may be in contact with at least a portion of the outer surface of the cooking device mounted on the heat source generating device 42 to function as a support surface for supporting the cooking device. The cooking heat source generating unit 40 may generate a heat source for cooking the cooking object accommodated in the cooking device. To this end, the cooking heat source generating unit 40 may be selectively coupled to the inner side of the plurality of upper support parts 30 radially disposed from the center of the coupling part 10 and supported by the upper support part 30.

At this time, the cooking heat source generating unit 40 may include a seating frame 31 provided to be in contact with each of the plurality of the upper support parts 30 disposed radially from the center of the second coupling frame 12 and a heat source generating device 42 coupled to the seating frame 41. The seating frame 41 may include a bottom part to which the heat source generating device is coupled and a plurality of the sidewall parts 412 extending upwardly from at least a portion of the circumferential surface of the bottom part 411. In this case, the plurality of sidewall parts 412 may be radially disposed from the center of the bottom part 411. Two adjacent sidewall parts 412 among the plurality of sidewall parts 412 may be spaced apart from each other by a predetermined interval. In other words, between two adjacent sidewall parts 412 among the plurality of sidewall parts, which is the circumferential surface of the bottom part 411 to which the side wall part 412 is not connected can be seated on the seating groove 331 provided in the extension support part 33. At this time, the outer side surface of the extension support part 33 corresponding to the upper side of the seating groove 331 is in contact with the inner surface of the sidewall part 412, thereby a flow of the extension support part 33 can be prevented.

The heat source generating device 42 may be provided as, for example, a gas burner. The gas container 2 required to be connected to the gas burner may be coupled to a separate bracket 2131 connected to the mounting hole 213 provided in the first support member 21. In the present embodiment, a case in which the heat source generating device 42 is a gas burner will be described as an example, but this is only an example for convenience of description, and thus, the concept of the present invention is not limited thereto.

The cooking device fixing part 50 may maintain the cooking device connected to the cooking device connecting means 521 in a state spaced apart from the ground. In addition, the cooking device fixing part 50 may adjust the distance between the cooking device connected to the cooking device connecting means 521 and the ground. To this end, the cooking device fixing part 50 may include a fixing frame 51, a wheel member 52, an adjustment bar 53, and a rotation limiting member 54. The fixing frame 51 may be selectively fixed to the lower side of the first coupling frame 11. The fixing frame 51 includes a fastening part 511 selectively fastened to the lower side of the first coupling frame 11, a first extension part 512 extending from both ends of the coupling part 511 and a second extension part 513 extending from both ends of the first extension part 512.

The wheel member 52 may be provided rotatably on the second extension part 513, and be configured that the cooking device connecting means 521 is selectively wound around the circumferential surface. The adjustment bar 53 may be rotatably provided on the first extension part 512. The adjustment bar 53 is provided to extend from the rotation connecting part 531 rotatably connected to the first extension part 512 and the end of the rotation connecting part 531, and may include the contact part 531 provided to be in contact with the cooking device connecting means 521 wound around the circumferential surface of the wheel member 52, and an external force applying part 533 connected to the contact part.

On the other hand, when an external force is applied to the cooking device connecting means 521 wound around the circumferential surface of the wheel member 52, for example, a chain, the cooking device connecting means 521 is moved along the direction in which the external force is applied so that the wheel member 52 can be rotated. At this time, as the cooking device connecting means 521 moving along the direction of the external force pushes the contact part 532 upward, so that the contact part 532 and the external force applying part 533 are rotated upwardly around the rotation connecting part 531. However, when the external force is removed from the cooking device connecting means 521, the contact part 532 and the external force applying part 533 rotated upwardly rotate downwardly around the rotation connecting part 531, thereby returning to the original position again. The contact portion 532 returned to the original position in this way presses the cooking device connecting means 521, thereby fixing the cooking device connecting means 521 to the circumferential surface of the wheel member 52. In this case, the contact part 532 may include an inclined part 5321 through which the cooking device connecting means 521 wound around the circumferential surface of the wheel member 52 can ride over. The inclined portion 5321 may prevent the cook device connecting means 521 from moving in a direction opposite to the direction of the external force applied to the cooking device connecting means 521. In addition, the contact part 532 is provided with a fixing piece 5322 so that the contact area with the cooking device connecting means 521 is improved, and thus it can be further prevented by the contact portion 532 that the cooking device connecting means 521 fixed to the circumferential surface of the wheel member 52 is separated from the circumferential surface of the wheel member 52.

The rotation limiting member 54 is coupled to the first extension 512 and provided to interfere with the adjustment bar 53, thereby limiting the rotation of the adjustment bar 53. For example, when an external force is applied to the cooking device connecting means 521, when defining the rotation direction of the adjustment bar 53 rotated by the cooking device connecting means 521 moving along the direction of the external force in one direction, the rotation limiting member 54 may be in contact with the adjustment bar 53 rotated in the other direction to prevent the adjustment bar 53 from being rotated in the other direction.

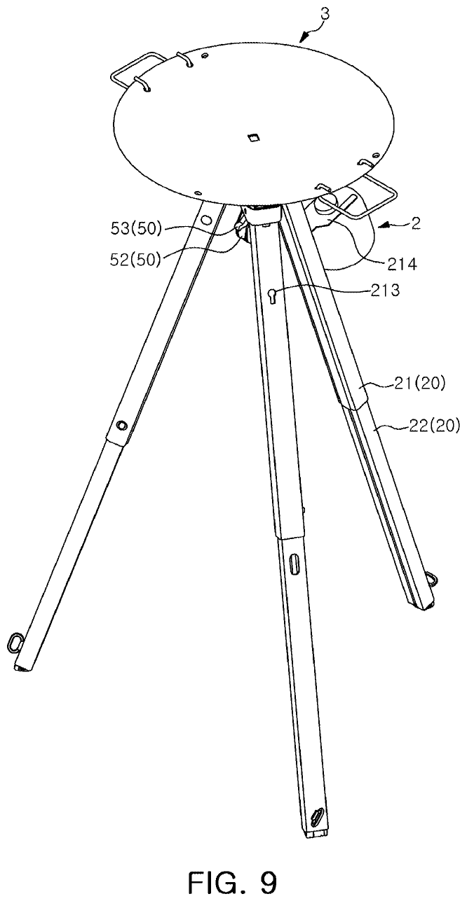

Hereinafter, with reference to FIGS. 9 to 11, the action and effect of the assembly type cooking device for outdoor activities according to an embodiment of the present invention will be described.

Referring to FIGS. 9 to 11, the assembly type cooking device for outdoor activities 1a may be used as a cooking device cooking the cooking object using the cooking device (3, 4) such as a skillet, a Dutch oven, etc. according to the type of the cooking object that the user wants to cook, the cooking method of the cooking object, the user's preference, and the like. At this time, the cooking device (3, 4) such as a skillet, a Dutch oven, etc. according to the type of the cooking object that the user wants to cook, the cooking method of the cooking object, the user's preference, and the like may be disposed on the lower side of the coupling part 10, for example, inside the plurality of the lower support part 20 disposed radially from the center of the coupling part 10, or be disposed on the upper side of the coupling part 10, for example, inside the plurality of the upper support part 30 disposed radially from the center of the coupling part 10.

When briefly describes a method of assembling the assembly type cooking device for outdoor activities 1a, first, the user pulls the plurality of lower support parts 20 connected to the lower side of the coupling part 10 in a direction away from the center of the coupling part 10, respectively, so that each of the lower support parts 20 is unfolded.

Next, the user adjusts the length of the lower support part 20 in consideration of the type of the cooking object, the cooking method of the cooking object, the user's preference, and the like. For example, the user moves the second support member 22 away from the first support member 21 until the length of the lower support part 20 becomes a desired length, or the user moves the second support member 22 from the second support member 22 to the third support member 24 and then can complete adjusting the length adjustment of the lower support part 20 by fixing them to each other. When the length adjustment of the lower support part 20 is completed, the plurality of upper support parts 30 are fastened to the upper side of the coupling part 10, and the heat source generating unit 40 for cooking is intuitively fastened to the upper side of the plurality of upper support parts 30, thereby completing the assembly of the assembly type cooking device for outdoor activities.

On the other hand, the assembly type cooking device for outdoor activities 1a assembled in this way, as shown in FIG. 9, is coupled to the cooking device 3 such as a skillet on the upper side of the plurality of the upper support part 30 is fastened to the upper side of the plurality of upper support parts 30, and may be used as a device cooking the cooking object with a heat source generated the heat source generating unit 40 for cooking is generated.

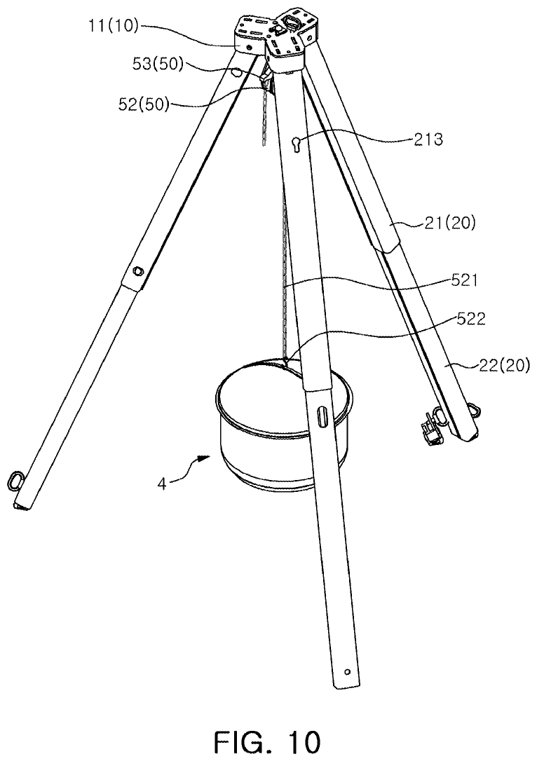

Contrary to this, as shown in FIG. 10, the assembly type cooking device for outdoor activities 1a is fastened to the cooking device fixing part 50 of the cooking device 4 such as a Dutch oven, and then may be used as a device cooking the cooking object with a heat source generated from the heat source generating device (not shown) disposed on the ground. At this time, the cooking device (4) may be connected to the cooking device fixing part 50 through a separate ring member 522 and the cooking device connecting means 521. Here, the cooking device fixing part 50 has functions to fix the cooking device 4 apart from the ground and to adjust the distance between the cooking device 4 and the ground.

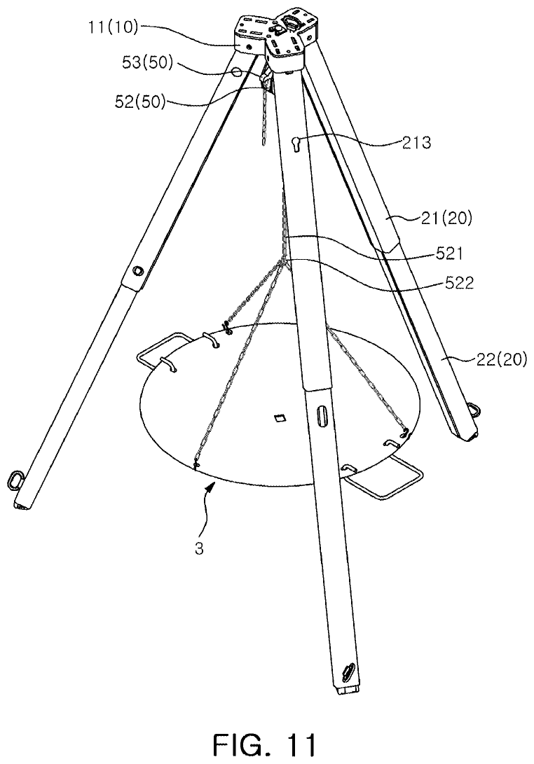

On the other hand, the assembly type cooking device for outdoor activities 1a, as shown in FIG. 11, may be used as a device in which the cooking device 3 such as a skillet may be fastened to the cooking device fixing part 50 and then the cooking object is cooked with the heat source generated from the heat source generating device (not shown). In this case, the cooking device 3 may be connected to the cooking device fixing part 50 through a separate ring member 522 and a cooking device connecting means 521. Here, the cooking device fixing part 50 may serve to fix the cooking device 3 so that the cooking device 3 is spaced apart from the ground.

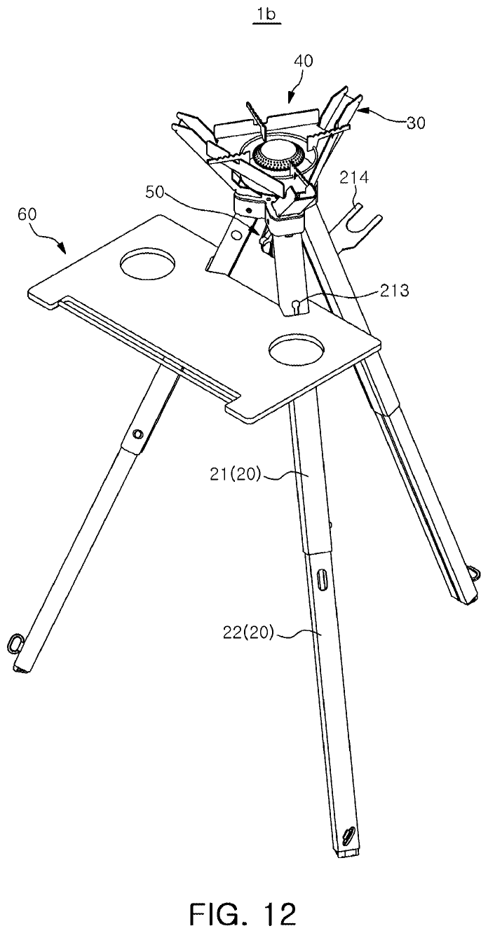

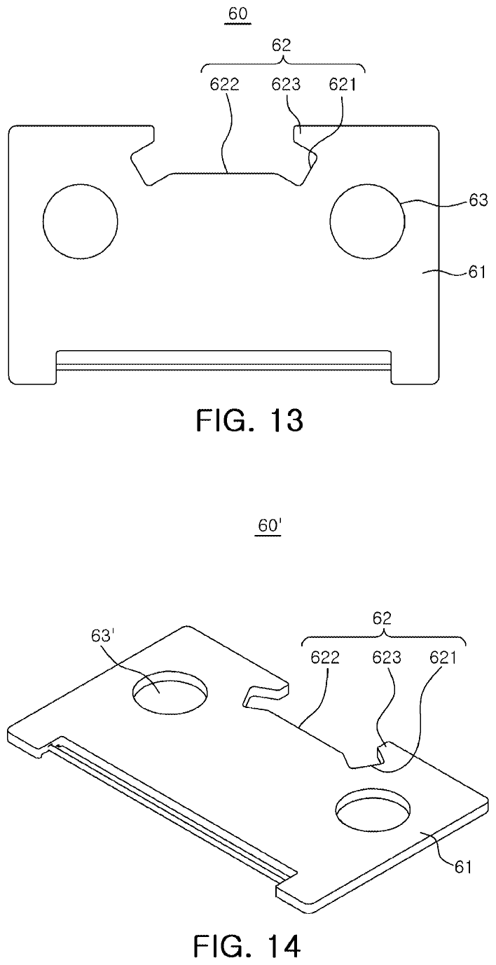

Hereinafter, an assembly type cooking device for outdoor activities 1b according to another embodiment of the present invention will be described with reference to FIGS. 12 and 13.

Referring to FIGS. 12 and 13, the assembly type cooking device for outdoor activities 1b according to another embodiment of the present invention may include a coupling part 10, a plurality of lower support parts 20, a plurality of upper support parts 30, a heat source generating unit for cooking 40, a cooking device fixing part 50, and a table member 60. However, the assembly type cooking device for outdoor activities 1b shown in FIG. 13 is substantially the same as the assembly type cooking device for outdoor activities 1a described with reference to FIGS. 1 to 8 except for the table member 60, Hereinafter, the table member 60 corresponding to the difference will be described, and the description and reference numerals of the above-described embodiment will be used for the same parts.

The table member 60 may provide a seating surface on which an object to be cooked, cooked food, outdoor items such as cooking utensils, and other personal items may be seated. In addition, the table member 60 can further enhance the convenience of outdoor activities by allowing users who are active in outdoor activities to easily access cooking objects, cooked food, outdoor items such as cooking utensils, and other personal items. To this end, the table member 60 may be selectively mounted to the lower support part 20. At this time, the table member 60 may include a table body 61, a mounting part 62 provided on the table body 61 and provided in close contact with the lower support part 20 to fix the table body 61 to the lower support part 20, and a seating support part 63 provided on the table body 61.

The table body 61 is a part on which a cooking object, cooked food, outdoor items such as cooking devices, and other personal items are seated, and can be mounted on at least one lower support part 20 of the plurality of lower support parts 20 by the mounting part 62.

The table body 61 may be mounted on the first support member 21 of the two lower support parts 20 disposed adjacently among the plurality of lower support parts 20. Accordingly, as the load of cooking objects, cooked food, outdoor items such as cooking device, and other personal items, applied to the table body 61, is distributed to the lower support part 20 stably fixed to the ground, cooking objects, cooked food, outdoor items such as cooking utensils, and other personal items can be supported more stably.

At this time, in a state in which the table body 61 is mounted on the first support member 21, when the second support member 22 is moved with respect to the first support member 21, or the second support member 22 is moved with respect to the second support member 22, the length of the lower support part 20 is adjusted, and the distance between the table body 61 and the ground is adjusted, so that the table body 61 can be used at a height desired by the user.

In the above-mentioned, in this embodiment, the table body 61 has been described as an example in which the table body 61 is mounted on the two lower support parts 20 disposed adjacently among the plurality of lower support parts 20 as an example, but this is only an example and, because of this, the concept of the present invention is not limited.

On the other hand, although not shown, in order to improve storage convenience, the table body 61 may be additionally provided with a folding part. When the table body 61 is provided to be foldable around the foldable part, the volume of the table body 61 becomes more compact when the table body 61 is stored, so that storage convenience can be increased.

The mounting part 62 allows the table body 61 to be intuitively fastened to the first support member 21. In addition, it is possible to prevent the table body 61 mounted on the first support member 21 from being separated from the first support member 21 by the mounting part 62.

To this end, the mounting part 62 may be formed by recessed at least a portion of the circumference of the table body 61. In this case, the mounting portion 62 may be provided in a number corresponding to the number of the first support members 21 to which the table body 61 is mounted.

The mounting part 62 includes a first part 621 provided in a shape corresponding to the shape of the outer surface of the first support member 21, and a second part 622 connected to one end of the first part 621, and a third part 623 connected to the other end of the second part 622. For example, the first part 621, the second part 622, and the third part 623 may be integrally formed.

In this case, the second part 622 may extend in a direction shifting from an extension direction of one end of the first part 621, and the third part 623 may extend in a direction shifting from an extension direction of the other end of the first part 621. In this case, a direction in which the second part 622 extends from one end of the first part 621 may be different from a direction in which the third portion 623 extends from the other end of the first part 621.

On the other hand, when considered as a reference that the table body 61 is mounted on the first support member 21 of the two lower support parts 20 disposed adjacently among the plurality of lower support parts 20, the first part 621 may be in close contact with a portion of the circumferential surface of the first support member 21, and the third part 623 may be in close contact with a circumferential surface that is not in close contact with the first part 621 among the circumferential surfaces of the first support member 21. The second part 622 may be positioned between two lower support parts 20 adjacently disposed among the plurality of lower support parts 20. Therefore, as the first support member 21 is surrounded by and blocked by the first part 621 and the third part 623, there is no fear that the table body 61 is separated from the first support member 21.

The seating support part 63 is a part on which outdoor goods or personal articles such as a cup or a tumbler are selectively seated and are supported, and may be provided in the table body 61. The seating support part 63 may be provided as a groove formed through the table body 61. In this case, the lower end of the cup or tumbler may be in contact with the surface of the seating support part 63′. Accordingly, a frictional force is generated between the lower end of the cup or tumbler and the surface of the seating support part 63′, and by the generated frictional force, the cup or tumbler may be supported by the seating support part 63′.

In this case, the seating support parts 63 may be provided as a pair in order to improve usability. The pair of seating support parts 63 may be spaced apart from each other at predetermined intervals along the longitudinal direction of the table member 61. However, this is only an example for convenience of description, and thus, the concept of the present invention is not limited. The number or arrangement of the seating support parts 63 may be variously modified in consideration of the user's convenience.

On the other hand, FIG. 14 shows a modified example of the table member of the assembly type cooking device for outdoor activities according to another embodiment of the present invention.

Referring to FIG. 14, the seating support part 63′ may be provided with a hole that is recessed from the surface of the table body 61. In this case, the inner surface of the seating support part 63 may be in contact with the outer surface of the cup or tumbler. Due to this, a frictional force is generated between the inner surface of the seating support part 63 and the outer surface of the cup or tumbler, and the cup or the tumbler are supported by the seating support part 63 due to this frictional force.

On the other hand, in the present embodiment, in order to improve the convenience of use, the seating support parts 63′ are provided as a pair, and the pair of seating support parts 63′ are spaced at predetermined intervals along the longitudinal direction of the table member 61. Although the case where they are spaced apart has been described as an example, this is only an example for convenience of description, and thus, the concept of the present invention is not limited. The number or arrangement of the seating support parts 63′ may be variously modified in consideration of user convenience.

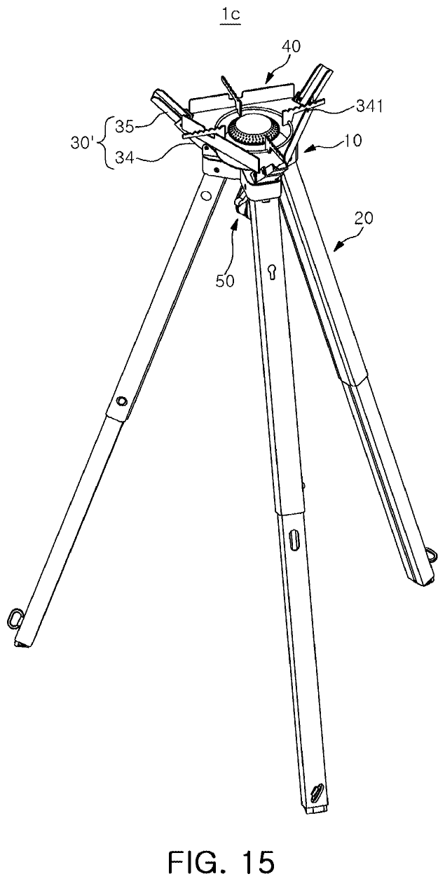

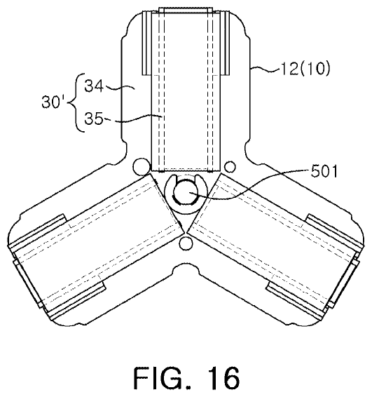

Hereinafter, an assembly type cooking device for outdoor activities 1c according to another embodiment of the present invention will be described with reference to FIGS. 15 and 16.

Referring to FIGS. 15 and 16, the assembly type cooking device for outdoor activities 1c according to another embodiment of the present invention may include a coupling part 10, a plurality of lower support parts 20, a plurality of upper support parts 30′, a cooking heat source generating unit 40 and a cooking device fixing part 50. However, when the assembly type cooking device for outdoor activities 1c shown in FIGS. 15 and 16 except for the plurality of upper support parts 30′, the assembly type cooking device 1a described with reference to FIGS. 1 to 8, and therefore hereinafter, a plurality of upper support parts 30′ corresponding to differences will be described, and descriptions and reference numerals of the above-described embodiments will be used for the same parts.

The plurality of upper support parts 30′ may selectively support the cooking heat source generating unit 40. To this end, the plurality of upper support parts 30′ may be rotatably connected to the lower side of the coupling part 10, may be provided to be adjustable in length, and may be disposed radially from the center of the coupling part 10.

At this time, the plurality of upper support parts 30′ may include the rotation support bar 34 rotatably coupled to the upper side of the coupling unit 10 and at least one movable support bar movably coupled to the rotation support bar 34.

The rotation support bar 34 is a portion rotatably connected to the second coupling frame 12, and one end of the rotation support bar 34 may be hinged to the second coupling frame 12, and the other end of the rotation support bar 34 may be hinged to the movable support bar 35. At this time, the rotation support bar 34 may have an accommodation space that can selectively accommodate the movable support bar 35. For example, the rotation support bar 34 may be formed in a ⊏-shape in cross section. Accordingly, the rotation support bar 34 is rotated in one direction with respect to the second coupling frame 12 and stored in a state in which the rotation support bar 34 is accommodated inside, and when use is necessary, the rotation support bar 34 can be rotated in other directions.

When the rotation support bar 34 is rotated with respect to the second coupling frame 12, the movable support bar 35 accommodated in the rotation support bar 35 may be rotated from the rotation support bar 34. When the rotation of the moving support bar 35 with respect to the rotating support bar 34 is completed, the seating frame 41 of the cooking heat source generating unit 40 may be supported on provided on the seating groove 341 provided in at least one of the rotating support bar 34 and the moving support bar 35. By the degree to which the rotation support bar 34 is rotated with respect to the second coupling frame 12, the prefabricated seating frames 41 of various sizes may be supported by the rotation support bar 34.

At this time, a heat source generating device 42 is coupled to the seating frame 41 supported by the seating groove 341, and a separate cooking device (not shown) may be mounted on the heat source generating device 42. In this case, the end of the movable support bar 35 may be in contact with at least a portion of the outer surface of the cook device mounted on the heat source generating device 42 to function as a support surface for supporting the cook device. For example, the movable support bar 35 may be formed in a ⊏-shape in cross section, and an end serving as a support surface may be inclined in a direction shifting from the extending direction of the movable support bar 35.

As such, the movable support bar 35 is provided to be rotated from the rotation support bar 34 only when necessary, so even if the plurality of upper support parts 30′ is integrally formed with the coupling part 10, the compact volume of the assembly type cooking device for outdoor activities 1c is maintained, it is possible to prevent deterioration in storage convenience.

In the above-mentioned, the case where one movable support bar 35 is rotatably connected to the rotation support bar 34 and the upper support part 30′ is provided in two stages has been described as an example, but this is only an example, and, for this reason, the concept of the present invention is not limited. For example, the plurality of movable support bars 35 are rotatably connected to the rotation support bar 34 so that the upper support part 30′ may be provided in three or more stages.

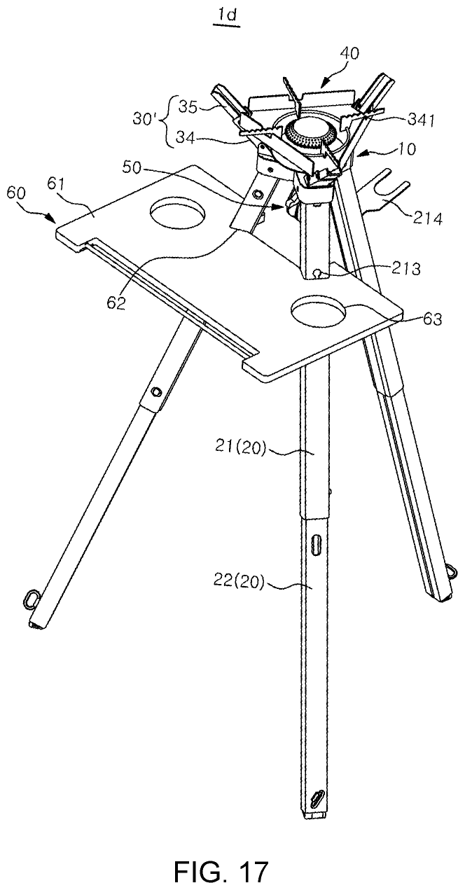

Meanwhile, FIG. 17 shows a assembly type cooking device for outdoor activities 1d according to another embodiment of the present invention.

Referring to FIG. 17, the assembly type cooking device for outdoor activities 1d according to another embodiment of the present invention includes a coupling part 10, a plurality of lower support parts 20, a plurality of upper support parts 30′, a heat source generating unit for cooking 40, a cooking device fixing part 50, and a table member 60. However, the assembly type cooking device for outdoor activities 1d shown in FIG. 17 is substantially the same as the assembly type cooking device for outdoor activities 1c described with reference to FIGS. 15 and 17 except for the table member 60, and the table member 60 is substantially the same as the table member 60 of the assembly type cooking device for outdoor activities 1b shown in FIGS. 12 and 13, therefore overlapping description is omitted.

Although the embodiments of the present invention have been described as specific embodiments, these are merely examples, and the present invention is not limited thereto, and should be interpreted as having the widest scope according to the basic idea disclosed in the present specification. A person skilled in the art may implement a pattern of a shape not specified by combining/substituting the disclosed embodiments, without departing from the scope of the present invention. In addition, those skilled in the art can easily change or modify the disclosed embodiments based on the present specification, and it is clear that such changes or modifications also fall within the scope of the present invention.

1-24. (canceled)

25. An assembly type cooking device for outdoor activities comprising: a coupling part; and a plurality of lower support parts rotatably connected to the lower side of the coupling part, provided to be adjustable in length, and radially disposed from the center of the coupling part.

26. The assembly type cooking device for outdoor activities according to claim 25, wherein the lower support part comprises: a first support member rotatably coupled to the coupling part; a second support member movably coupled to the first support member; and a first length adjustment part provided on the first and second support members, the first length adjustment part fixing the second support member moved relative to the first support member to the first support member.

27. The assembly type cooking device for outdoor activities according to claim 26, wherein the lower support part further comprises: a third support member movably coupled to the second support member; and a second length adjustment part provided on the second and third support members, the second length adjustment part fixing the third support member moved relative to the second support member to the second support member.

28. The assembly type cooking device for outdoor activities according to claim 26, wherein a plurality of contact members is provided inside the coupling part, the contact member is disposed outside the first support member and is provided to surround at least a portion of a circumferential surface of the first support member.

29. The assembly type cooking device for outdoor activities according to claim 28, wherein the contact member includes a protrusion formed to protrude from one surface of an outer peripheral surface, and the protrusion is provided so that an end portion is in contact with the inner peripheral surface of the coupling part.

30. The assembly type cooking device for outdoor activities according to claim 28, wherein a support jaw for selectively supporting the first support member is provided on the inner surface of the contact member.

31. The assembly type cooking device for outdoor activities according to claim 30, wherein the coupling part comprises: a first coupling frame to which the plurality of the lower support parts is rotatably coupled; and a second coupling frame provided on the first coupling frame.

32. The assembly type cooking device for outdoor activities according to claim 31, wherein the first coupling frame comprises: a first connecting part; a plurality of second connecting parts radially connected from the center of the first connecting part and rotatably connected to the lower support part; and a protrusion provided on at least a portion of the inner surface of the second connecting part.

33. The assembly type cooking device for outdoor activities according to claim 32, wherein the contact member is provided between the first connecting part and the second connecting part, and the first support member rotating between the first connecting part and the second connecting part is supported by the support jaw.

34. The assembly type cooking device for outdoor activities according to claim 25, further comprising a plurality of upper support parts selectively coupled to the upper side of the coupling part, disposed radially from the center of the coupling part and having a seating groove, wherein the seating groove provided in the plurality of the upper support parts are radially disposed from the center of the coupling part to form a support structure.

35. The assembly type cooking device according to claim 34, wherein the coupling part comprises: a first coupling frame to which the plurality of the lower support parts is rotatably coupled; and a second coupling frame provided on the first coupling frame, and to which the plurality of the upper support parts is selectively coupled.

36. The assembly type cooking device for outdoor activities according to claim 35, wherein the second coupling frame comprises: a third coupling part; and a plurality of fourth coupling parts radially connected from the center of the third coupling part and to which the upper support part is selectively coupled, and wherein the fourth coupling part is provided with an insertion slit into which the upper support part can be inserted.

37. The assembly type cooking device for outdoor activities according to claim 36, wherein the upper support part comprises: an insertion portion provided to be insertable into the insertion slit; a latching portion connected to the insertion portion, the latching portion selectively interfering with the inner surface of the insertion slit to prevent the insertion portion inserted into the insertion slit from being detached from the insertion slit; and an extension support part extending from the insertion portion and provided with the seating groove.

38. The assembly type cooking device for outdoor activities according to claim 36, wherein the upper supporter comprises: a rotation support bar rotatably coupled to the upper side of the coupling part; and at least one movable support bar movably coupled with the rotation support bar, wherein the seating groove is provided in at least one of the rotation support bar and the movable support bar.

39. The assembly type cooking device for outdoor activities according to claim 34, further comprising a cooking heat source generating unit selectively seated in the seating groove disposed radially from the center of the coupling part and supported by the upper support part.

40. The assembly type cooking device for outdoor activities according to claim 39, wherein the cooking heat source generating unit comprises: a seating frame capable of being seated on and supported by the seating groove; and a heat source generating device coupled to the seating frame.

41. The assembly cooking device for outdoor activities according to claim 25, further comprising a cooking device fixing part provided on the lower side of the coupling part inside a plurality of the lower support parts radially disposed from the center of the coupling part.

42. The assembly cooking device for outdoor activities according to claim 41, wherein the cooking device fixing part further comprises a fixed frame selectively fixed to the lower side of the coupling portion, and wherein the fixed frame comprises: a fastening part selectively fastened to the lower side of the coupling part; a first extension part extending from both ends of the fastening part; and a second extension part extending from both ends of the first extension part.

43. The assembly type cooking device for outdoor activities according to claim 42, wherein the cooking device fixing part comprises: a wheel member rotatably provided to the second extension part and provided so that a cooking device connecting means is selectively wound around the circumferential surface; and an adjustment bar rotatably provided in the first extension part.

44. The assembly type cooking device for outdoor activities according to claim 43, wherein the adjustment bar comprises: a rotation connecting part rotatably connected to the first extension part; a contact part extending from the end of the rotation connecting part and provided to be in contact with the cooking device connecting means wound around the circumferential surface of the wheel member; and an external force applying part connected to the contact part, and wherein the contact part comprises an inclined part that the cooking device connecting means wound on the circumferential surface of the wheel member can ride over.

45. The assembly type cooking device for outdoor activities according to claim 44, wherein the contact part further comprises a fixing piece for improving a contact area with the cooking device connecting means wound on the circumferential surface of the wheel member.

46. The assembly type cooking device for outdoor activities according to claim 43, wherein the cooking device fixing part further comprises a rotation limiting member coupled to the first extension and provided to interfere with the adjustment bar to limit rotation of the adjustment bar.

47. The assembly type cooking device for outdoor activities according to claim 25, further comprising a table member selectively mounted to the lower support part.

48. The assembly type cooking device for outdoor activities according to claim 47, wherein the table member comprises: a table body; a mounting part provided on at least a portion of the peripheral surface of the table body and provided in close contact with at least a portion of the peripheral surface of the lower support part to mount the table body to the lower support part; and a seating support part provided on the table body.
